(19) United States
(12) Patent Application Publication
(10) Pub. No.: US 2010/0299672 A1
(43) Pub. Date: Nov. 25, 2010

(54) MEMORY MANAGEMENT DEVICE, COMPUTER SYSTEM, AND MEMORY MANAGEMENT METHOD

(75) Inventors: Hiroki TAGAWA, Kanagawa (JP); Shunsuke Sasaki, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/692,076

(22) Filed: Jan. 22, 2010

(30) Foreign Application Priority Data
May 25, 2009 (JP) 2009-125540

(51) Int. Cl. G06F 9/46; G06F 12/00; G06F 12/02

(52) U.S. Cl. 718/104; 711/170; 711/E12.001; 711/E12.084

(57) ABSTRACT

A memory management device includes a memory area, an allocator generating unit that generates a plurality of allocators, which allocates a memory resource of the memory area to a task, for respective rules of allocation/deallocation of the memory resource, and a task correlating unit that selects one of generated allocators based on an allocator specification that is different for each task by the task and sets such that the task is capable of using selected allocator.

### CROSS-REFERENCE TO RELATED APPLICATIONS

This application is based upon and claims the benefit of priority from the prior Japanese Patent Application No. 2009-125540, filed on May 25, 2009; the entire contents of which are incorporated herein by reference.

### BACKGROUND OF THE INVENTION

1. Field of the Invention

The present invention relates to a memory management device, a computer system, and a memory management method.

2. Description of the Related Art

Conventionally, a general-purpose multi-tasking operating system (OS) employs a “paging” in which a memory is divided into “pages” of a fixed size (for example, 4 KBytes) and an allocation/deallocation is performed for each page. With this method, for example, when a task requests allocation of a memory area of 400 KBytes, the OS performs a process of searching for 100 free pages and returning a position of each found page. At this time, when the pages in use present in a dispersed manner, the process of searching for a free space needs to be performed a large number of times (100 times in the worst case). In other words, the memory use efficiency is not high in the paging. This is because single rule (memory management policy) of allocating/deallocating a memory every 4 KBytes is applied for all tasks regardless of the processing content.

As a technology for dealing with the above problem, Japanese Patent Application Laid-open No. 2005-338985 discloses a technology of appropriately changing a physical storage area to be allocated to each computer in accordance with the states of computers in a storage system. However, with this technology, only the area to be allocated for each computer is changed and the rule of allocation/deallocation is not changed, so that the above problem is not solved.

### BRIEF SUMMARY OF THE INVENTION

A memory management device according to an embodiment of the present invention comprises:

a memory area;

an allocator generating unit that generates a plurality of allocators, which allocates a memory resource of the memory area to a task, for respective rules of allocation/deallocation of the memory resource; and

a task correlating unit that selects one of generated allocators based on an allocator specification that is different for each task by the task and sets such that the task is capable of using selected allocator.

A computer system according to an embodiment of the present invention comprises:

a memory area;

a task that operates by using the memory area;

an allocator generating unit that generates a plurality of allocators, which allocates a memory resource of the memory area to the task, for respective rules of allocation/deallocation of the memory resource; and

a task correlating unit that selects one of generated allocators based on an allocator specification that is different for each task by the task and sets such that the task is capable of using selected allocator.

A memory management method according to an embodiment of the present invention comprises:

generating a plurality of allocators, which allocates a memory resource of a memory area included in a computer system to a task, for respective rules of allocation/deallocation of the memory resource; and

setting including
selecting one of generated allocators based on an allocator specification that is different for each task by the task performed in the computer system, and
setting such that the task is capable of using selected allocator.

### BRIEF DESCRIPTION OF THE DRAWINGS

FIG. 1 is a diagram explaining a paging;

FIG. 2 is a diagram for schematically explaining a memory management operation by a memory management device according to a first embodiment;

FIG. 3 is a diagram explaining a hardware configuration of the memory management device according to the first embodiment;

FIG. 4 is a diagram explaining a function of the memory management device according to the first embodiment;

FIG. 5 is a diagram explaining a data structure of an allocator;

FIG. 6 is a flowchart explaining an operation of the memory management device according to the first embodiment;

FIG. 7 is a diagram explaining an example of a data structure of task management data;

FIG. 8 is a diagram schematically explaining an operation of a memory management device according to a second embodiment;

FIG. 9 is a diagram schematically explaining an operation of a memory management device according to a third embodiment;

FIG. 10 is a diagram explaining a function of the memory management device according to the third embodiment;

FIG. 11 is a flowchart explaining an operation of the memory management device according to the third embodiment;

FIG. 12 is a diagram explaining an example of the task management data; and

FIG. 13 is a diagram explaining an example of the task management data.

### DETAILED DESCRIPTION OF THE INVENTION

Exemplary embodiments of a memory management device, a computer system, and a memory management method according to the present invention will be explained below in detail with reference to the accompanying drawings. The present invention is not limited to the following embodiments.

A memory management device in a first embodiment of the present invention is mounted on a computer that includes a processor and a nonvolatile memory such as a random access memory (RAM). Specifically, the function as the memory management device in the first embodiment is realized on the computer by the processor of the computer reading out a kernel program from a read only memory (ROM), an external storage device, or the like and executing it.

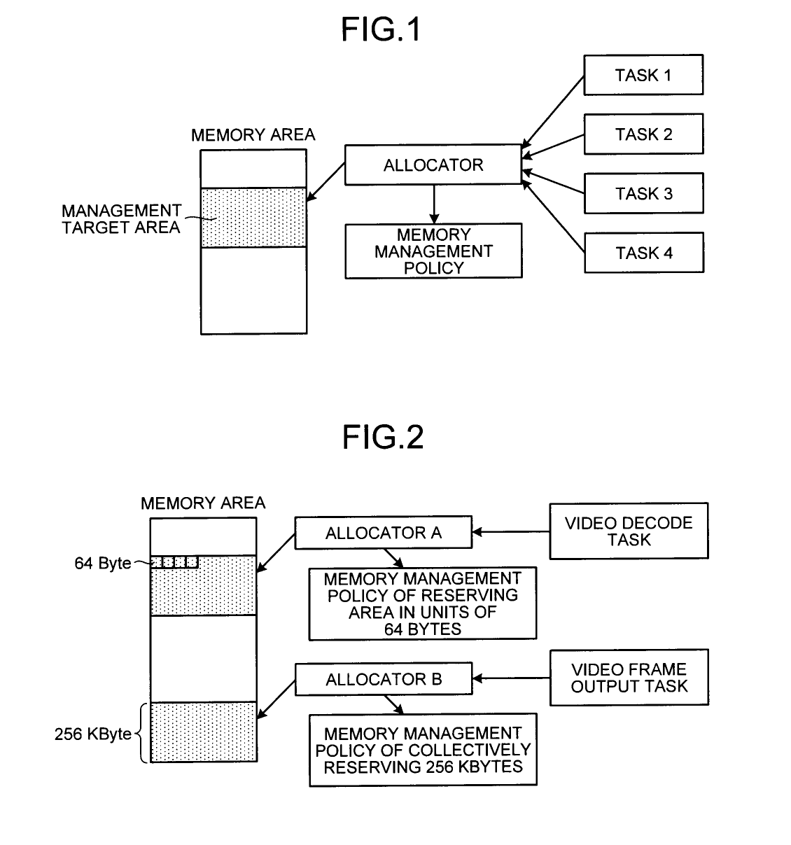

First, a paging is taken as a comparison example and the characteristics of the first embodiment are explained while comparing with the comparison example. FIG. 1 is a diagram for schematically explaining a memory management operation in an OS employing the paging. As shown in FIG. 1, a management target area as a dedicated area for allocating tasks is reserved in a memory area of a nonvolatile memory, and the tasks started from a kernel program reserve/release a memory from this management target area by using an allocator for performing a memory allocation/deallocation. In the OS that employs the paging, the allocator performs the memory allocation/deallocation by using single memory management policy of allocating/deallocating a memory every 4 KBytes. Therefore, even in the case of a task that needs to perform the memory allocation with a size of 4 Kbytes or more, the memory allocation needs to be performed every 4 KBytes, which results in increasing the number of times of processing of searching for a free space and reserving the searched free space, thereby lowering the memory use efficiency.

FIG. 2 is a diagram for schematically explaining a memory management operation by the memory management device according to the first embodiment. The memory management device in the first embodiment includes a plurality of memory management policies, and is configured such that each task can select one of a plurality of allocators that uses a plurality of the memory management policies (in this example, two memory management policies) respectively in accordance with the processing content. In FIG. 2, an allocator A that uses the memory management policy of performing the memory allocation/deallocation every 64 Bytes and an allocator B that uses the memory management policy of performing the memory allocation/deallocation every 256 KBytes are generated, and a video decode task that reserves a memory as needed in units of 64 Bytes uses the allocator A and a video frame output task that collectively reserves a memory in units of 256 KBytes and uses it uses the allocator B. In other words, the video decode task and the video frame output task each use the allocator that uses the memory management policy appropriate for the processing content. In this manner, the first embodiment is mainly characterized in that a different allocator is generated for each memory management policy and a task uses one of the allocators, thereby enabling to use different memory management policies according to the processing content of the task, as a measure for improving the memory use efficiency compared with the paging. The memory management device in the first embodiment is explained below. In the explanation, the video decode task and the video frame output task described above are used as examples of tasks performed in the memory management device in the first embodiment.

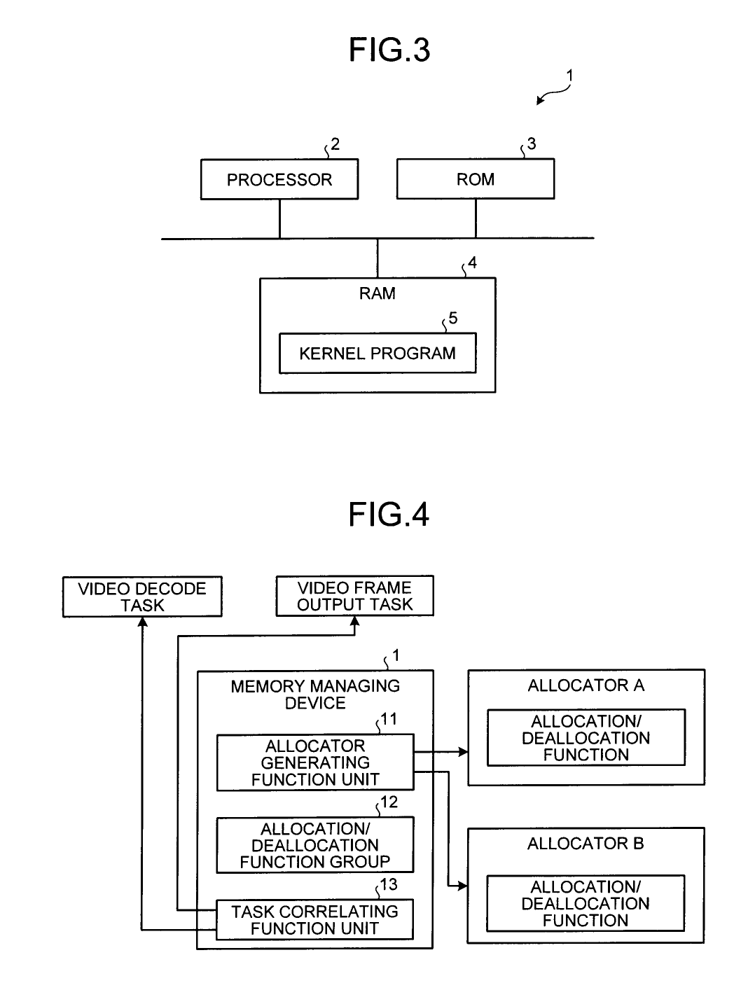

FIG. 3 is a diagram explaining a hardware configuration of the memory management device according to the first embodiment. As shown in FIG. 3, a memory management device 1 in the first embodiment has a computer configuration including a processor 2, a ROM 3, and a RAM 4. The processor 2, the ROM 3, and the RAM 4 are connected with each other via a bus line.

The processor 2 executes a kernel program as a memory management program that performs the memory management for the RAM 4. A kernel program 5 is stored in the ROM 3 and is loaded on the RAM 4 via the bus line. The processor 2 executes the kernel program 5 loaded on the RAM 4. Specifically, in the memory management device 1, the processor 2 reads out the kernel program 5 from the ROM 3 at the time of startup and loads the kernel program 5 on the program storing area in the RAM 4, and realizes the function of performing the memory management operation in the first embodiment by corporation of the kernel program 5 loaded on the RAM 4 and the processor 2. The function of performing the memory management operation in the first embodiment is explained later. The kernel program 5 can be stored in a storage device such as a disk. Alternatively, the kernel program 5 can be loaded on a storage device such as a disk.

The kernel program 5 executed in the memory management device 1 in the first embodiment can be provided in such a way that the kernel program 5 is stored in a computer connected to a network such as the Internet and is downloaded via the network. The kernel program 5 executed in the memory management device 1 in the first embodiment can also be provided or distributed via the network such as the Internet. Alternatively, the kernel program 5 in the first embodiment can be incorporated in a ROM or the like in advance and provided to the memory management device 1 in the first embodiment. In the following, the kernel program 5 is expressed simply as the kernel 5 in some cases.

FIG. 4 is a diagram explaining a function of the memory management device 1 in the first embodiment generated by executing the kernel 5. As shown in FIG. 4, the memory management device 1 includes an allocator generating function unit 11 that generates the allocator for each memory management policy, an allocation/deallocation function group 12 as a library of functions for providing various memory management policies to the allocators, and a task correlating function unit 13 that sets to enable the task to use the allocator by correlating the allocator generated by the allocator generating function unit 11 with the task executed by the kernel 5.

Specifically, the allocator generating function unit 11 selects an allocation function and a deallocation function from the allocation/deallocation function group 12 and embeds pointers for referring to the selected functions in the allocator, thereby providing the memory management policy as a rule of the memory allocation/deallocation to the allocator. In the following, the memory management policy is simply expressed as a rule in some cases. The allocation/deallocation function group 12 is explained to be included in the kernel 5; however, the allocation/deallocation function group 12 can be provided from a user program instead of from the kernel 5.

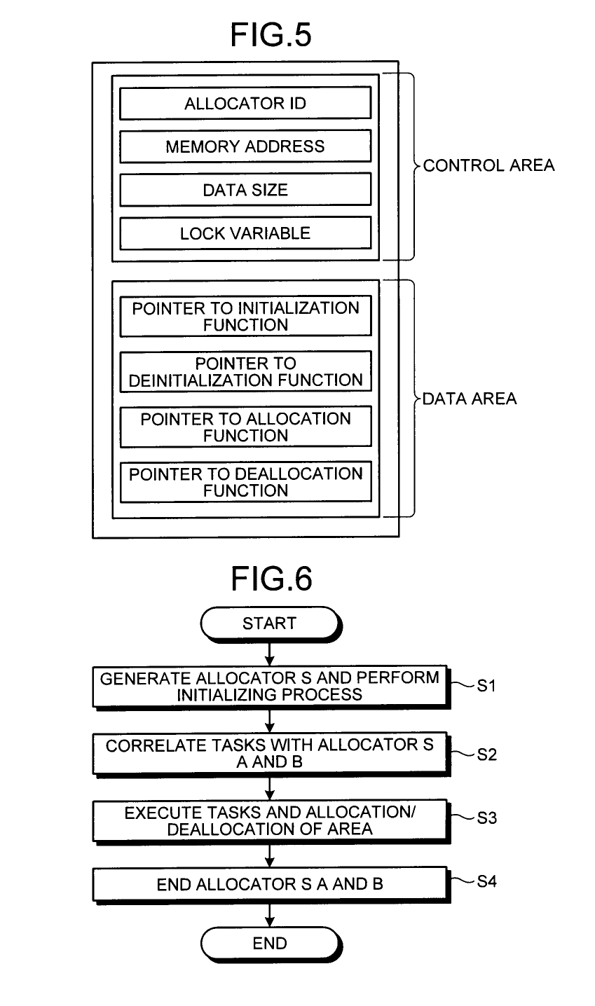

FIG. 5 is a diagram specifically explaining a data structure of the allocator. As shown in FIG. 5, the allocator includes a data area and a control area. The control area includes an allocator ID for identifying each of a plurality of the allocators, a memory address as a top address of the management target area, a data size of the management target area, and a lock variable that is used for mutual exclusion of the management target area determined based on the memory address and the data size. The management target area is reserved on the RAM 4. The data area includes pointers that indicate four functions (an initialization function, a deinitialization function, an allocation function, and a deallocation function). The initialization function is a function for reserving the management target area at the time of generating the allocator and initializing the reserved management target area. The deinitialization function is a function for deallocating the management target area at the time of ending the allocator and deleting the allocator. The allocation function and the deallocation function are functions that describe the memory management policy when allocating the memory area from the management target area. The rule at the time of the memory allocation is described in the allocation function. For example, a unit size of an area to be allocated can be specified in the allocation function. The deallocation function is a function in which a rule at the time of deallocating the allocated memory area is described. For example, the rule of the first in, first out (FIFO) can be realized by the deallocation function that is described to deallocate the areas in order from the area that is allocated first. Moreover, the rule of the first in, last out (FILO) can be realized by the deallocation function that is described to deallocate the areas in order from the area that is allocated last.

Next, the operation of the memory management device 1 in the first embodiment is explained. FIG. 6 is a flowchart explaining the operation of the memory management device 1. First, before starting the video decode task and the video frame output task, the allocator generating function unit 11 statically generates the allocator A and the allocator B (S1). Specifically, the allocator generating function unit 11 generates the data structures of the two allocators A and B and sets pointers of the four functions of the data area to each of them. In this example, the allocation function in which the “policy of reserving the memory area as needed in units of 64 Bytes” is described is selected from the allocation/deallocation function group 12 for the allocation function of the allocator A, and the allocation function in which the “policy of collectively reserving the memory area of 256 KBytes” is described is selected for the allocation function of the allocator B. The initializing process is performed when generating the allocator. In the initializing process, the allocator generating function unit 11 attaches the allocator ID to the generated allocator, sets the memory address and the data size in the control area in the data structure of the allocator based on the initialization function specified by the pointer to reserve the management target area in the RAM 4, and reserves the lock variable so that any allocator other than this generated allocator cannot use the reserved management target area.

After the process at S1, the task correlating function unit 13 correlates the video decode task and the video frame output task with the allocator A and the allocator B, respectively (S2). Specifically, the kernel 5 generates data (task management data) for task management for performing scheduling of the tasks and the like. Moreover, the allocator ID is specified in advance in the code of each task. The task correlating function unit 13 selects the allocator (in this case, the allocator A or the allocator B) that each task uses based on the allocator ID specified in the code of each task and embeds a pointer to each selected allocator in the task management data of each task before starting each task.

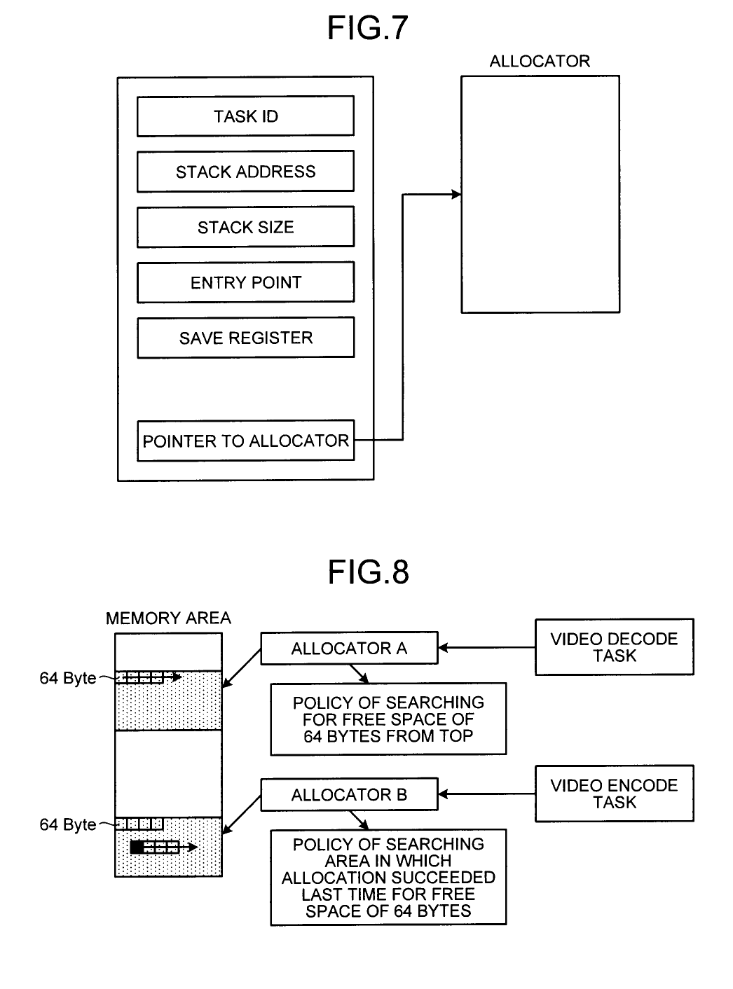

FIG. 7 is a diagram explaining an example of the data structure of the task management data of a video process task (the video decode task and the video frame output task) with which the allocator is correlated. As shown in FIG. 7, the task management data of the video process task is configured to include a task ID for identifying the task, a stack address in the RAM 4, a stack size as a size of a stack area, an entry point of this task, a save register, and a pointer to the allocator. The pointer indicating the allocator A is described in the pointer to the allocator in the task management data of this video decode task and the pointer indicating the allocator B is described in the task management data of the video frame output task by the task correlating function unit 13.

Returning to FIG. 6, the kernel 5 executes two video process tasks (the video decode task and the video frame output task) (S3). At this time, the kernel 5 executes the memory area allocation/deallocation by using the allocator correlated with the task management data as needed. In other words, the “policy of reserving the memory area as needed in units of 64 Bytes” is applied to the memory area allocation/deallocation that the video decode task uses, and the “policy of collectively reserving the memory area of 256 KBytes” is applied to the video frame output task.

After finishing the tasks, the memory management device 1 calls the deinitialization function by using each pointer described in the data structures of the unnecessary allocators A and B and performs the deinitialization function to delete the allocator A and the allocator B (S4).

As described above, according to the first embodiment, a plurality of allocators each for allocating a memory resource of the memory area to the task is generated for memory management policies, respectively, one of the generated allocators is selected based on the allocator specification described in the code of the task, and the allocator that the task selects can be used, so that the task can use the allocator that uses the memory management policy according to the processing content, thus enabling to improve the memory use efficiency compared with the paging.

Moreover, the management target area is reserved for each allocator, so that each allocator allocates the memory area from the management target area managed by itself. Therefore, the free space to be allocated to the task is easily searched for.

Furthermore, because a unit size of the memory resource to be allocated/deallocated in one allocation/deallocating operation is specified in the memory management policy, the task can set to use the allocator that uses the memory management policy of allocating/deallocating in a unit size appropriate for the processing content of the task, thus enabling to improve the memory use efficiency.

For example, the video encode task reserves the memory as needed in units of relatively small data size similarly to the above video decode task and uses the memory. However, it is known that, in the case of the video decode task, the searching efficiency is good when using a method of searching the memory area of the management target area for a free space from the top in each time and reserving the first found free space of 64 Bytes, and, in the case of the video encode task, the searching efficiency is good when searching the area in which the allocation of 64 Bytes succeeded last time for the free space. Thus, in a second embodiment, the method of searching for the space area is further described in the allocation function.

FIG. 8 is a diagram schematically explaining an operation of a memory management device according to the second embodiment. As shown in FIG. 8, the video decode task performs the memory allocation by using the allocator A that uses the policy of searching for the free space of 64 Bytes from the top, and the video encode task performs the memory allocation by using the allocator B that uses the policy of searching the area in which the allocation succeeded last time for the free space of 64 Bytes.

The hardware configuration and the functional configuration for realizing the above operation are similar to those in the first embodiment and only the description of the allocation function is different, so that the detailed explanation of the hardware configuration and the functional configuration in the second embodiment is omitted. Moreover, the detailed explanation of the operation is approximately the same as that in the first embodiment except for the schematic explanation, so that it is also omitted.

As explained above, according to the second embodiment, the searching rule for the free space of the memory area for allocating to the task is specified in the memory management policy, so that the memory use efficiency can be improved.

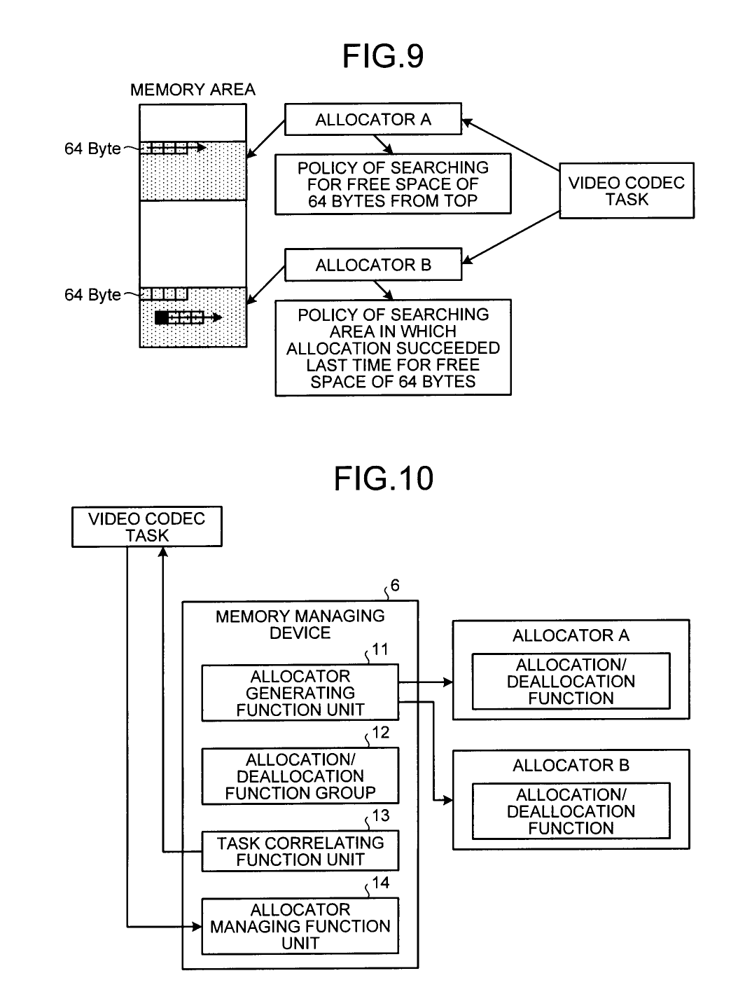

In a third embodiment, each task can switch a plurality of allocators and use it. For example, the video codec task that is single task that performs decoding and encoding of the video is considered. FIG. 9 is a diagram schematically explaining an operation of a memory management device according to the third embodiment when the video codec task is performed. As shown in FIG. 9, the video codec task reserves the memory area as needed in units of relatively small data size (in this example, 64 Bytes) and uses it. At the time of the decoding, the video codec task uses the allocator A that uses the memory management policy of searching the memory area of the management target from the top for the free space and reserving the first found free space of 64 Bytes, and at the time of the encoding, the video codec task uses the allocator B that uses the memory management policy of searching the area in which the allocation of 64 Bytes succeeded last time for the free space and reserving the first found free space of 64 Bytes.

The configuration of the memory management device in the third embodiment is explained. The hardware configuration of the memory management device in the third embodiment is similar to that in the first embodiment, so that explanation thereof is omitted. FIG. 10 is a diagram explaining a function of the memory management device according to the third embodiment. For distinguishing the memory management device in the third embodiment from the first embodiment, the reference numeral “6” is attached to the memory management device in the third embodiment.

As shown in FIG. 10, a memory management device 6 in the third embodiment includes an allocator managing function unit 14 in addition to the functional configuration in the first embodiment. The allocator managing function unit 14 manages the allocator generated by the allocator generating function unit 11, and, when receiving a request for specifying the allocator from the task before or during execution, causes the task correlating function unit 13 to correlate this task with the specified allocator.

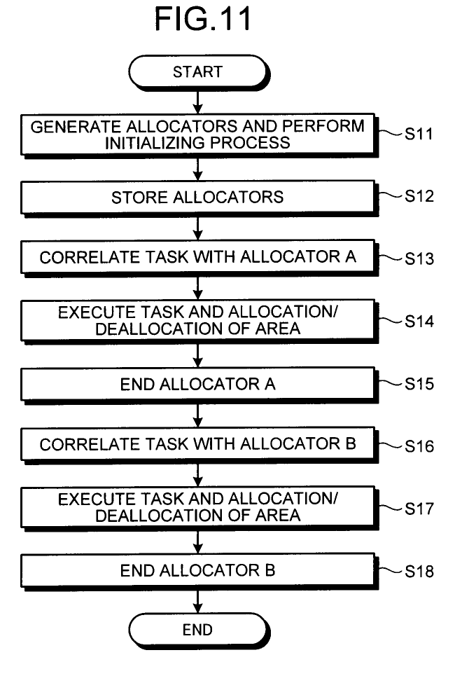

Next, the operation of the memory management device 6 in the third embodiment is explained. FIG. 11 is a flowchart explaining the operation of the memory management device 6 according to the third embodiment.

In FIG. 11, first, the allocator generating function unit 11 statically generates the allocator A and the allocator B before startup of the task (S11). The data structure of each allocator is similar to that in the first embodiment. However, the allocator generating function unit 11 is set to select the allocation function in which the “policy of searching for the free space of 64 Bytes from the top” is described from the allocation/deallocation function group 12 for the allocator A and select the allocation function in which the “policy of reserving the free space of 64 Bytes from the area in which the allocation succeeded last time” is described for the allocator B. The allocator managing function unit 14 stores therein the allocator IDs of the allocator A and the allocator B generated by the allocator generating function unit 11 (S12).

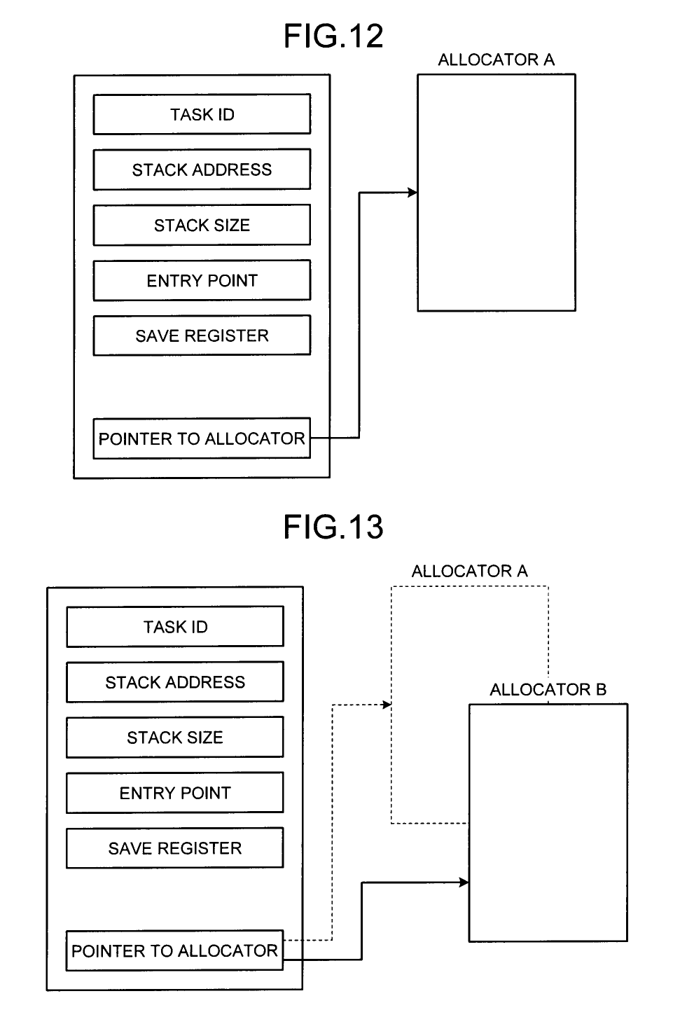

Next, the system control proceeds to the process of correlating the video codec task with the allocator A (S13). In this example, the video codec task inquires of the allocator managing function unit 14 about whether the allocator A presents by specifying the ID of the allocator A. Because the inquired allocator A is registered, the allocator managing function unit 14 instructs the task correlating function unit 13 to statistically correlate the video codec task with the allocator A before startup of the video codec task. FIG. 12 is a diagram explaining an example of the task management data of the video codec task with which the allocator A is correlated. As shown in FIG. 12, the pointer indicating the allocator A is embedded as the pointer to the allocator.

Subsequent to S13, the kernel 5 executes the video decode function of the video codec task (S14). At this time, the kernel 5 executes the memory area allocation/deallocation as needed by using the allocator A that is correlated with the task management data. In other words, the “policy of searching for the free space of 64 Bytes from the top” is applied to the memory area allocation/deallocation that the video codec task uses.

Next, after finishing the execution of the video decode function, the memory management device 6 calls the deinitialization function of the allocator A and performs the deinitialization function to delete the allocator A (S15). At this time, the allocator managing function unit 14 deletes the stored ID of the allocator A.

Next, the video codec task inquires of the allocator managing function unit 14 about whether the allocator B presents by specifying the ID of the allocator B. Because the inquired allocator B is registered, the allocator managing function unit 14 instructs the task correlating function unit 13 to correlate the video codec task with the allocator B (S16). FIG. 13 is a diagram explaining an example of the task management data of the video codec task with which the allocator B is correlated. As shown in FIG. 13, the pointer indicating the allocator B is embedded as the pointer to the allocator instead of the allocator A.

Next, the kernel 5 executes the video encode function of the video codec task (S17). At this time, the kernel 5 executes the memory area allocation/deallocation as needed by using the allocator B that is correlated with the task management data. In other words, the “policy of reserving the free space of 64 Bytes from the area in which the allocation succeeded last time” is applied to the memory area allocation/deallocation that the video codec task uses.

Then, after finishing the execution of the video encode function, the memory management device 6 calls the deinitialization function of the allocator B and performs the deinitialization function to delete the allocator B (S18), and the operation ends. At this time, the allocator managing function unit 14 deletes the stored ID of the allocator B.

As described above, according to the third embodiment, the allocator set to the task is switched based on the specification (request) of the allocator issued from the task before and during the task, so that the allocators can be selectively used even when single task for performing a plurality of processing content is operated, thus enabling to improve the memory use efficiency.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory management device comprising:
a memory area;
an allocator generating unit that generates a plurality of allocators, which allocates a memory resource of the memory area to a task, for respective rules of allocation/deallocation of the memory resource; and
a task correlating unit that selects one of generated allocators based on an allocator specification that is different for each task by the task and sets such that the task is capable of using selected allocator.

2. The memory management device according to claim 1, wherein
the allocator generating unit reserves a different management target area in the memory area for each of the generated allocators, and
each of the allocators generated by the allocator generating unit allocates a memory resource included in a management target area reserved to the each of the allocators to a task that uses the each of the allocators.

3. The memory management device according to claim 2, wherein
a plurality of allocation functions for allocating a memory resource and a plurality of deallocation functions for deallocating allocated memory resource are included, and
each of the allocators generated by the allocator generating unit performs an allocation of a memory resource by using one of the allocation functions and performs a deallocation of a memory resource by using one of the deallocation functions.

4. The memory management device according to claim 3, wherein each of the allocators generated by the allocator generating unit includes a data structure that includes a description specifying an allocation function and a deallocation function used by the each of the allocators.

5. The memory management device according to claim 1, wherein the allocator specification is described in a code of the task.

6. The memory management device according to claim 1, wherein
the allocator specification is an allocator specification request that is issued by the task before and during execution of the task and specifies one of the allocators generated by the allocator generating unit, and
the memory management device further includes a task switching unit that, when the allocator specification request is issued, causes the task correlating unit to set such that the task that issues the allocator specification request is capable of using an allocator specified by issued allocator specification request.

7. The memory management device according to claim 3, wherein
a unit size of a memory resource allocated in one allocation operation is specified in each of the allocation functions, and
a unit size of a memory resource deallocated in one deallocation operation is specified in each of the deallocation functions.

8. The memory management device according to claim 3, wherein the allocation functions include an allocation function in which a method of searching reserved management target area for a free space for performing a memory allocation is specified.

9. A computer system comprising:
a memory area;
a task that operates by using the memory area;
an allocator generating unit that generates a plurality of allocators, which allocates a memory resource of the memory area to the task, for respective rules of allocation/deallocation of the memory resource; and
a task correlating unit that selects one of generated allocators based on an allocator specification that is different for each task by the task and sets such that the task is capable of using selected allocator.

10. The computer system according to claim 9, wherein
the allocator generating unit reserves a different management target area in the memory area for each of the generated allocators, and
each of the allocators generated by the allocator generating unit allocates a memory resource included in a management target area reserved to the each of the allocators to a task that uses the each of the allocators.

11. The computer system according to claim 10, wherein
a plurality of allocation functions for allocating a memory resource and a plurality of deallocation functions for deallocating allocated memory resource are included, and
each of the allocators generated by the allocator generating unit performs an allocation of a memory resource by using one of the allocation functions and performs a deallocation of a memory resource by using one of the deallocation functions.

12. The computer system according to claim 9, wherein the allocator specification is described in a code of the task.

13. The computer system according to claim 9, wherein
the allocator specification is an allocator specification request that is issued by the task before and during execution of the task and specifies one of the allocators generated by the allocator generating unit, and
the computer system further includes a task switching unit that, when the allocator specification request is issued, causes the task correlating unit to set such that the task that issues the allocator specification request is capable of using an allocator specified by issued allocator specification request.

14. The computer system according to claim 11, wherein
a unit size of a memory resource allocated in one allocation operation is specified in each of the allocation functions, and
a unit size of a memory resource deallocated in one deallocation operation is specified in each of the deallocation functions.

15. The computer system according to claim 11, wherein the allocation functions include an allocation function in which a method of searching reserved management target area for a free space for performing a memory allocation is specified.

16. A memory management method comprising:
generating a plurality of allocators, which allocates a memory resource of a memory area included in a computer system to a task, for respective rules of allocation/deallocation of the memory resource; and
setting including
selecting one of generated allocators based on an allocator specification that is different for each task by the task performed in the computer system, and
setting such that the task is capable of using selected allocator.

17. The memory management method according to claim 16, further comprising:
performing an allocation of a memory resource by using one of a plurality of allocation functions for allocating a memory resource by generated allocators; and
performing a deallocation of allocated memory resource by using one of a plurality of deallocation functions for deallocating the allocated memory resource by the generated allocators.

18. The memory management method according to claim 16, wherein the allocator specification is described in a code of the task.

19. The memory management method according to claim 16, wherein
the allocator specification is an allocator specification request that is issued by the task before and during execution of the task and specifies one of the allocators generated by the allocator generating unit, and
the setting includes setting such that, when the allocator specification request is issued, the task that issues the allocator specification request is capable of using an allocator specified by issued allocator specification request.

20. The memory management method according to claim 17, further comprising:
specifying a unit size of a memory resource allocated in one allocation operation in each of the allocation functions; and
specifying a unit size of a memory resource deallocated in one deallocation operation in each of the deallocation functions.
